(19) United States
(12) Patent Application Publication
(10) Pub. No.: US 2012/0312573 A1
(43) Pub. Date: Dec. 13, 2012

(54) ELECTRICAL POWER TOOL

(75) Inventor: Kenya YANAGIHARA, Anjo-shi (JP)

(73) Assignee: MAKITA CORPORATION, Anjo-shi (JP)

(21) Appl. No.: 13/482,347

(22) Filed: May 29, 2012

(30) Foreign Application Priority Data
Jun. 10, 2011 (JP) 2011-129929

(51) Int. Cl. H02K 5/00

(52) U.S. Cl. 173/170

(57) ABSTRACT

An electrical power tool may include a tool housing that is formed by connecting an outer circumferential surface of a motor housing containing a motor therein and a proximal end portion of a handle. The handle has a grip portion provided to a portion close to a distal end portion thereof and having a trigger switch to activate the motor, Power-supply cords of the motor arc introduced into the tool housing through a power-supply cord insertion portion that is positioned in a portion of a proximal end portion of the handle. A distribution path of the power-supply cords is positioned in a portion other than the grip portion of the handle.

### BACKGROUND OF THE INVENTION

1. Field of the Invention

The present invention relates to an electrical power tool. More particularly, the present invention relates to an electrical power tool having a tool housing that is formed by connecting an outer circumferential surface of a motor housing containing a motor therein to a proximal end portion of a handle, in which the handle has a grip portion provided to a distal end portion thereof and having a trigger switch to activate the motor, and in which power-supply cords of the motor are introduced into the tool housing through a power-supply cord insertion portion that is positioned in a middle portion of the handle.

2. Description of Related Art

A hand-held circular saw (an electrical power tool) is taught by, for example, Japanese Laid-Open Patent Publication No. 2006-116815. As shown in FIG. 4, the hand-held circular saw has a base 102 having a rectangular shape in plan view, and a circular saw main body 105 disposed on the base 102. The circular saw main body 105 has a motor 107m to rotate a disk-shaped saw blade 104, and a reduction mechanism, The motor 107m and the reduction mechanism are contained in a motor housing 107. The portable circular saw further has a handle 108 having a U-shape in side view. A distal end and a proximal end of the handle 108 are respectively connected to a circumferential surface of the motor housing 107. Further, a grip portion 108g having a trigger switch 108t to activate the motor 107m is provided to a portion close to the distal end portion of the handle 108. In addition, the handle 108 has a cord insertion opening 108k through which (first and second) cords 110a and 110b (power-supply cords) of the motor 107m are introduced thereinto. The cord insertion opening 108k is formed in a middle portion (a portion close to the proximal end portion) of the handle 108.

The cords 110a and 110b are capable of being connected to an electrical outlet (not shown) via a plug (not shown). As shown in a circuit diagram of FIG, 5, the first cord 110a connected to one end (a plus (+) terminal) of the plug is connected to one end of the trigger switch 108t. Further, the other end of the trigger switch 108t is connected to one end of the motor 107m via a connecting wire 110c. Conversely, the second cord 110b connected to the other end (a minus (−) terminal) of the plug is connected to the other end of the motor 107m.

The portable circular saw thus constructed can be actuated by operating the trigger switch 108t after the plug is connected to the electrical outlet.

However, in the portable circular saw, the cords 110a and 110b (the power-supply cords) and the connecting wire 110c through which a load current of the motor 107m flows are connected to the motor 107m via the trigger switch 108t attached to the grip portion 108g. Therefore, as shown in FIG. 4, the first cord 110a (the power-supply cords) and the connecting wire 110c are introduced into the grip portion 108g. This means that a cord length of the power supply cords (an entire length of the cords 110a and 110b and the connecting wire 110c) is relatively increased. The increased cord length of the power-supply cords may increase line resistance. This may lead to a voltage drop, heat generation or other such adverse effects. Thus, there is a need in the art for an improved electrical power tool.

### BRIEF SUMMARY OF THE INVENTION

In one aspect of the present invention, an electrical power tool may include a tool housing that is formed by connecting an outer circumferential surface of a motor housing containing a motor therein and a proximal end portion of a handle. The handle has a grip portion provided to a portion close to a distal end portion thereof and having a trigger switch to activate the motor. Power-supply cords of the motor are introduced into the tool housing through a power-supply cord insertion portion that is positioned in a portion of a proximal end portion of the handle. A distribution path of the power-supply cords is positioned in a portion other than the grip portion of the handle.

According to this aspect, because the distribution path of the power-supply cords is positioned in a portion other than the grip portion of the handle, the power-supply cords can extend from the power-supply cord insertion portion to the motor housing passing through the proximal end portion of the handle without passing through the grip portion of the handle, so as to be connected to the motor. As a result, a cord length of the power-supply cords can be reduced compared with a conventional circular saw in which power-supply cords are connected to a motor via a trigger switch. Thus, it is possible to reduce line resistance of the power-supply cords.

The electrical power tool may include a motor control device having switching elements. The motor control device is configured to control an amount of electricity to be fed to the motor based on a signal from the trigger switch. The motor control device can be positioned in the proximal end portion of the handle such that the power-supply cords can be distributed in the proximal end portion of the handle. Conversely, the motor control device can be positioned in the distal end portion of the handle such that the power-supply cords can be distributed in the proximal end portion and the distal end portion of the handle,

Other objects, features and advantages of the present invention will be readily understood after reading the following detailed description together with the accompanying drawings and the claims.

### BRIEF DESCRIPTION OF THE DRAWINGS

FIG. 1 is a circuit diagram of a motor control device of a portable circular saw according to a representative embodiment of the present invention;

FIG. 2 is a partially cutaway side view of the circular saw;

FIG. 3 is a partially cutaway side view of a circular saw according to a modified form of the embodiment;

FIG. 4 is a partially cutaway side view of a conventional circular saw; and

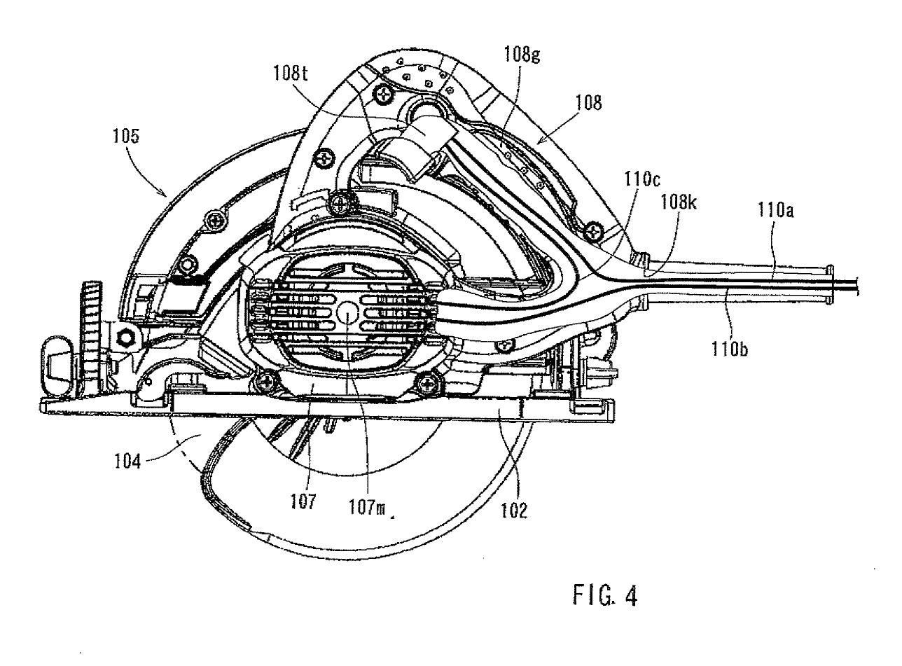

FIG. 5 is a circuit diagram of a motor control device of the conventional circular saw.

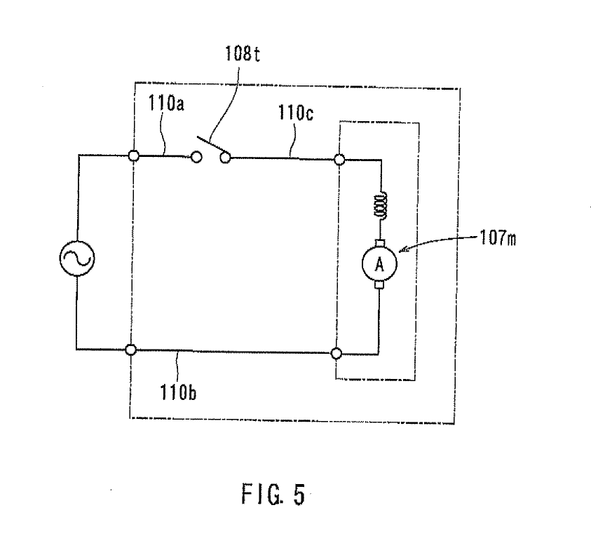

### DETAILED DESCRIPTION OF THE INVENTION

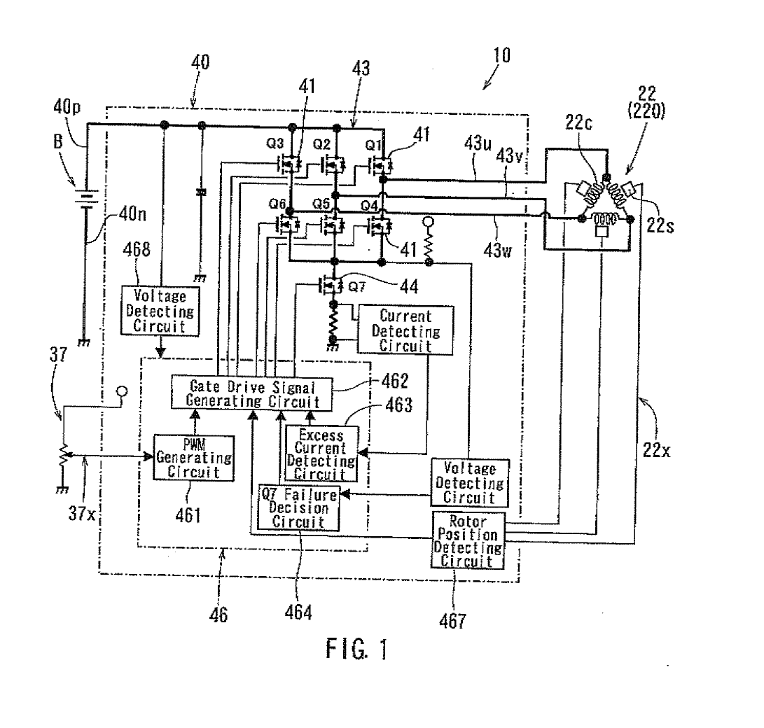

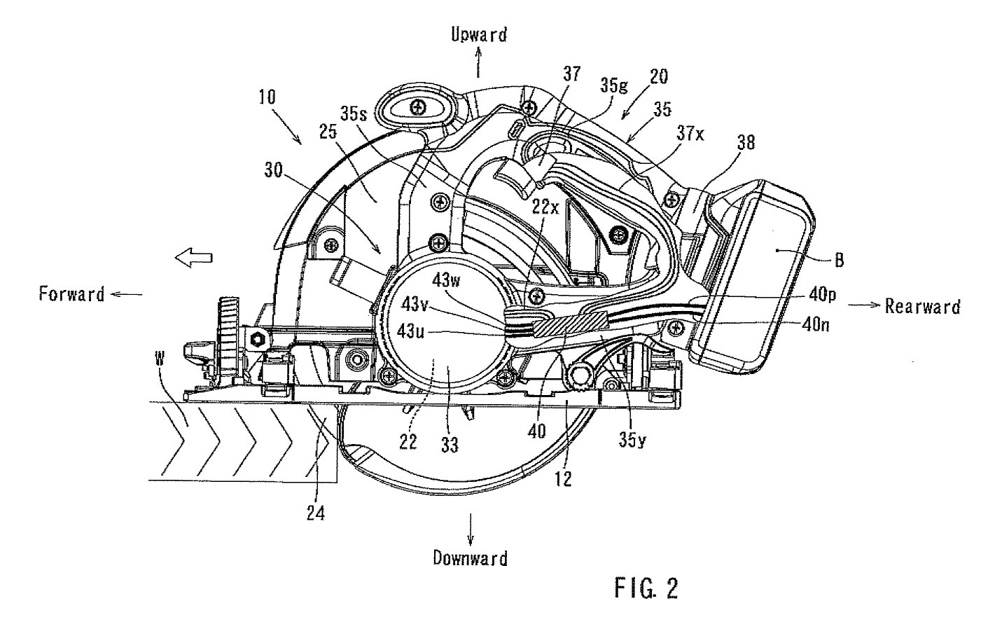

A detailed representative embodiment of the present invention will be described with reference FIGS. 1 and 2. In the embodiment, a battery-powered portable circular saw 10 (which will be simply referred to as a circular saw 10) may be exemplified as an electrical power tool.

Further, forward and rearward, rightward and leftward, and upward and downward in the drawings respectively correspond to forward and rearward, rightward and leftward, and upward and downward of the circular saw 10.

As shown in. FIG. 2, the circular saw 10 may include a base 12 and a circular saw main body 20 disposed on the base 12. The base 12 may have a rectangular shape in plan view and is configured to be placed on an upper surface of a cutting object W. The circular saw main body 20 may have a motor 22 (a drive source) and a reduction mechanism (not shown) that are coupled to each other. The reduction mechanism may have an output shaft or spindle (not shown) to which a disk-shaped saw blade 24 is coaxially connected. A lower portion of the saw blade 24 may be protruded downwardly from a lower surface of the base 12, so as to form a protruded portion. The protruded portion of the saw blade 24 may be configured to be cut into the cutting object W. Conversely, an upper portion of the saw blade 24 positioned above the base 12 may be circumferentially covered by a blade cover 25. Further, the motor 22 and the reduction mechanism may be contained in a cylindrical motor housing 33 that constitutes a tool housing 30.

Further, as shown in FIG, 2, the circular saw 10 may have a handle 35 that constitutes the tool housing 30. The handle 35 may be connected to a circumferential surface of the motor housing 33 at a position close to a coupling portion of the motor 22 and the reduction mechanism. The handle 35 may preferably have a substantially inverted C-shape and may include a vertical portion 35s that is extended upwardly from an upper portion of the circumferential surface of the motor housing 33, a grip portion 35g that is extended obliquely rearwardly from an upper end of the vertical portion 35s, and a connecting portion 35y that connects a rear (proximal) end portion of the grip portion 35g to a rear portion of the circumferential surface of the motor housing 33. Further, the handle 35 may have a trigger switch 37 to activate the motor 22. The trigger switch 37 may preferably be attached to a lower side of a front (distal) end portion of the grip portion 35g of the handle 35.

Further, the handle 35 may have a battery attachment portion 38 that is formed in the rear end portion of the grip portion 35g. The battery attachment portion 38 may preferably be directed obliquely downwardly. The battery attachment portion 38 may be configured such that a battery pack B (a power source) can be detachably attached thereto.

Further, as shown in FIG. 2, the circular saw 10 may include a motor control device 40. The motor control device 40 is connected to the battery attachment portion 38 via cords 40p and 40n, so that electric power can be fed from the battery pack B attached to the battery attachment portion 38 to the motor control device 40.

Further, the vertical portion 35s and the connecting portion 35y of the handle 35 may respectively be referred to as a distal end portion and a proximal end portion of the handle 35. Also, the cords 40p and 40n may be referred to as power-supply cords. In addition, the battery attachment portion 38 of the handle 35 a portion of the connecting portion 35y of the handle 35) may be referred to as a power-supply cord insertion portion through which the power-supply cords are introduced.

The motor 22 may be a brushless DC motor. As shown in FIG. 1, the motor 22 may be composed of a rotor (not shown) having a permanent magnet, a stator 220 having three-phase drive coils 22c, and three magnetic sensors 22s that are attached to the stator 220 in order to detect a position ea magnetic pole of the rotor.

The motor control device 40 may be configured to activate the motor 22 when the trigger switch 37 attached to the grip portion 35g of the handle 35 is manipulated. As shown in FIG. 1, the motor control device 40 may have a three-phase bridge circuit portion 43 that is composed of six switching elements 41 (Q1 to Q6), a current interrupting switching element 44 (Q7) that is positioned in series with the three-phase bridge circuit portion 43, and a control portion 46 that is configured to control the three-phase bridge circuit portion 43 based on a signal from the trigger switch 37 and to monitor a current and a voltage.

As shown by thick lines in FIG, 1, the motor control device 40 may be connected to the battery attachment portion 38 via the cords 40p and 40n, Thus, the electric power can be fed from the battery pack B to the motor control device 40 such that the three-phase bridge circuit portion 43 and the control portion 46 can be actuated. Further, the three-phase bridge circuit portion 43 may have three (U-phase, V-phase and W-phase) power cords 43u, 43v and 43w. The power cords 43u, 43v and 43w may respectively be connected to the corresponding three-phase drive coils 22c such that the electric power can be fed from the motor control device 40 to the motor 22.

Further, the power cords 43u, 43v and 43w may also be referred to as the power-supply cords.

The control portion 46 may include a PWM (pulse-width modulation) generating circuit 461 that is capable of transforming an amount of manipulation of the trigger switch 37 (an amount of change of a resistance value) to a pulse-width signal, a gate drive signal generating circuit 462 that is capable of driving the switching elements 41 (Q1 to Q6) of the three-phase bridge circuit portion 43 and the current interrupting switching element 44 (Q7), an excess current detecting circuit 463 that is capable of detecting an excess current of the motor 22, and a Q7 failure decision circuit 464 that is capable of performing a failure decision of the current interrupting switching element 44. Further, the control portion 46 may include a monitor circuit (not shown) that is capable of monitoring a battery voltage of the battery pack B, which voltage can be detected by a voltage detecting circuit 468.

The gate drive signal generating circuit 462 of the control portion 46 may be configured to activate the switching elements 41 (Q1 to Q6) of the three-phase bridge circuit portion 43 based on the pulse-width signal from the PWM generating circuit 461, so as to control an amount of electricity to be fed to the motor 22. Further, the gate drive signal generating circuit 462 may be configured to control activation timing of the switching elements 41 (Q1 to Q6) based on a position of the rotor. The position of the rotor can be determined by a rotor position detecting circuit 467 based on signals from the magnetic sensors 22s. Thus, the motor control device 40 can activate the motor 22 with an amount of electricity corresponding to the amount of manipulation of the trigger switch 37,

Further, the gate drive signal generating circuit 462 may be configured to turn off the current interrupting switching element 44 to open the circuit when a load current of the motor 22 is judged as the excess current. Also, the gate drive signal generating circuit 462 may be configured to turn off the switching elements 41 (Q1 to Q6) when the current interrupting switching element 44 is judged as being failed.

As shown in FIG. 2, the motor control device 40 may be contained in the connecting portion 35y of the handle 35 that constitutes the tool housing 30. Therefore, the cords 40p and 40n that are configured to feed the electric power from the battery pack B to the motor control device 40 may be distributed in the handle 35, so as to extend between the battery attachment portion 38 and an interior side of the connecting portion 35y. Conversely, the power cords 43u, 43v and 43w that are configured to feed the electric power from the motor control device 40 to the motor 22 may be distributed in the handle 35, so as to extend between the interior side of the connecting portion 35y to an interior side of the motor housing 33. That is, the power-supply cords (the cords 40p and 40n and the power cords 43u, 43v and 43w) may be distributed in the connecting portion 35y of the handle 35.

Further, as shown in FIG. 1, the motor control device 40 may be connected to the magnetic sensors 22s of the motor 22 via signal cords 22x. As shown in FIG. 2, the signal cards 22x may be distributed in the handle 35, so as to extend between the interior side of the connecting portion 35y and the interior side of the motor housing 33. In addition, as shown in FIG. 1, the motor control device 40 may be connected to the trigger switch 37 via signal cords 37x. As shown in FIG. 2, the signal cords 37x may be distributed in the handle 35, so as to extend between an interior side of the grip portion 35g and the interior side of the connecting portion 35y.

Further, the interior side of the connecting portion 35y of the handle 35 and the interior side of the motor housing 33 may be referred to as a distribution path of the power-supply cords (the cords 40p and 40n and the power cords 43u, 43v and 43w).

According to the circular saw 10 thus constructed, the motor control device 40 is contained in the connecting portion 35y of the handle 35. Therefore, the cords 40p and 40n and the power cords 43u, 43v and 43w (the power-supply cords) can extend from the battery attachment portion 38 to the interior side of the motor housing 33 passing through the interior side of the connecting portion 35y (the proximal end portion) of the handle 35, i.e., without passing through the interior side of the grip portion 35g of the handle 35, so as to be connected to the motor 22. Thus, the power-supply cords can be distributed in the proximal end portion of the handle 35. That is, the distribution path of the power-supply cords can be positioned in a portion other than the grip portion 35g of the handle 35. Further, the signal cords 37x connecting the motor control device 40 to the trigger switch 37 may be distributed in the grip portion 35g.

As a result, a cord length of the power-supply cords (i.e., an entire length of the cords 40p and 40n and the power cords 43u, 43v and 43w) is relatively reduced compared with a conventional circular saw in which power-supply cords are connected to a motor via a trigger switch. The reduced cord length of the power-supply cords may effectively reduce line resistance of the power-supply cords. Thus, it is possible to effectively prevent a voltage drop, heat generation or other such adverse effects.

In addition, the motor control device 40 is positioned between the battery attachment portion 38 (a middle portion of the handle 35) in which the Cord 40p and 40n (the power-supply cords) are introduced and the motor 22. Therefore, the cord length of the cords 40p and 40n and the power cords 43u, 43v and 43w (the power-supply cords) can be further reduced.

Further, the motor control device 40 has the three-phase bridge circuit portion 43 that is composed of the six switching elements 41, and the current interrupting switching element 44 that is capable of interrupting a motor current flowing through the three-phase bridge circuit portion 43. Therefore, even when the switching elements 41 of the three-phase bridge circuit portion 43 are failed, the motor current can be interrupted by the current interrupting switching element 44.

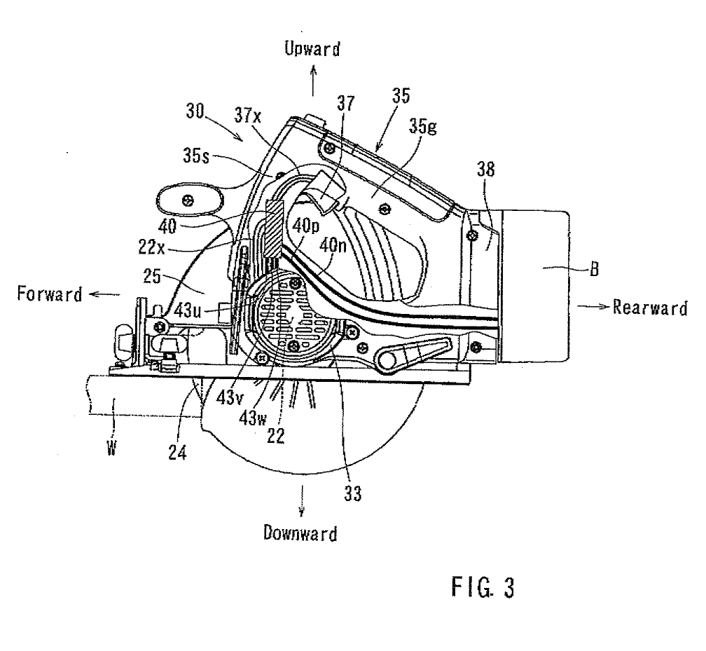

Various changes and modifications may be made to the present invention without departing from the scope of the previously shown and described embodiment. For example, in the embodiment, as shown in FIG. 2, the motor control device 40 is contained in the connecting portion 35y of the handle 35. However, as shown in FIG. 3, the motor control device 40 can be contained in the vertical portion 35s (the distal end portion) of the handle 35, i.e., between the trigger switch 37 and the motor 22. In such a modified form, the power-supply supply cords (the cords 40p and 40n and the power cords 43u, 43v and 43w) can be distributed in the proximal end portion and the distal end portion of the handle 35. That is, it is not necessary to introduce the power-supply cords (the cords 40p and 40n and the power cords 43u, 43v and 43w) into the grip portion 35g of the handle 35. As a result, the cord length of the power-supply cords can be reduced.

Further, in the embodiment, the battery-powered portable circular saw 10 is exemplified as the electrical power tool. However, the present invention can be applied to various electrical power tools each having a motor housing and a handle, in which a proximal end of the handle is connected to a circumferential surface of the motor housing, and in which a grip portion having a trigger switch that is provided to a portion close to a distal end of the handle has the handle.

Further, in the embodiment, the battery-powered portable circular saw 10 is exemplified as the electrical power tool. However, the present invention can be applied to a plug-in circular saw.

A representative example of the present invention has been described in detail with reference to the attached drawings. This detailed description is merely intended to teach a person of skill in the art further details for practicing preferred aspects of the present invention and is not intended to limit the scope of the invention. Only the claims define the scope of the claimed invention. Therefore, combinations of features and steps disclosed in the foregoing detailed description may not be necessary to practice the invention in the broadest sense, and are instead taught merely to particularly describe detailed representative examples of the invention. Moreover, the various features taught in this specification may be combined in ways that are not specifically enumerated in order to obtain additional useful embodiments of the present invention.

What is claimed is:

1. An electrical power tool, comprising:
a tool housing that is formed by connecting an outer circumferential surface of a motor housing containing a motor therein and a proximal end portion of a handle,
wherein the handle has a grip portion provided to a portion close to a distal end portion thereof and having a trigger switch to activate the motor,
wherein power-supply cords of the motor are introduced into the tool housing through a power-supply cord insertion portion that is positioned in the portion of a proximal end portion of the handle, and
wherein a distribution path of the power-supply cords is positioned in a portion other than the grip portion of the handle.

2. The electrical power tool as defined in claim I further comprising a motor control device having switching elements, wherein the motor control device is configured to control an amount of electricity to be fed to the motor based on a signal from the trigger switch, and wherein the power-supply cords are distributed to extend between a power source and the motor control device and between the motor control device and the motor.

3. The electrical power tool as defined in claim 2, wherein the motor control device is positioned between the power-supply cord insertion portion and the motor.

4. The electrical power tool as defined in claim 3, wherein the motor housing and the distal end portion of the handle are connected to each other, and wherein the motor control device is contained in the distal end portion of the handle, so as to be positioned between the motor and the trigger switch.

5. The electrical power tool as defined in claim 2, wherein the motor control device has a three-phase bridge circuit portion that is composed of six switching elements, and a current interrupting switching element that is capable of interrupting a motor current flowing through the three-phase bridge circuit portion.

6. The electrical power tool as defined in claim 1 further comprising a motor control device having switching elements, wherein the motor control device is configured to control an amount of electricity to be fed to the motor based on a signal from the trigger switch, and wherein the motor control device is contained in the proximal end portion of the handle such that the power-supply cords can be distributed in the proximal end portion of the handle.

7. The electrical power tool as defined in claim 1 further comprising a motor control device having switching elements, wherein the motor control device is configured to control an amount of electricity to be fed to the motor based on a signal from the trigger switch, wherein the distal end portion of the handle is connected to the motor housing, and wherein the motor control device is contained in the distal end portion of the handle such that the power-supply cords, can be distributed in the proximal end portion and the distal end portion of the handle.
